(19) United States
(12) Patent Application Publication
(10) Pub. No.: US 2019/0080327 A1
(43) Pub. Date: Mar. 14, 2019

(54) METHOD, APPARATUS, AND ELECTRONIC DEVICE FOR RISK FEATURE SCREENING AND DESCRIPTIVE MESSAGE GENERATION

(71) Applicant: ALIBABA GROUP HOLDING LIMITED, Grand Cayman (KY)

(72) Inventors: PENG ZHANG, HANGZHOU (CN); XIAOHUA YIN, SHANGHAI (CN); XIANGYANG ZHANG, CHENGDU (CN); FENG XUE, HANGZHOU (CN); XI GU, HANGZHOU (CN); QIANTING GUO, HANGZHOU (CN); JIANWEI TU, HANGZHOU (CN)

(21) Appl. No.: 16/127,583

(22) Filed: Sep. 11, 2018

(30) Foreign Application Priority Data
Sep. 12, 2017 (CN) 201710818502.9

(51) Int. Cl. G06Q 20/40; G06N 99/00

(52) U.S. Cl. CPC G06Q 20/4016; G06N 99/005

(57) ABSTRACT

A method for risk feature screening comprises: acquiring respective feature weights of a plurality of risk features, wherein the feature weights are either obtained by using a classification model trained using sample events or predefined, and wherein the classification model is configured to determine risk events; and selecting at least a part of the plurality of risk features through screening according to the feature weights and a predetermined constraint for limiting the length of a message generated based on the risk features.

### CROSS REFERENCE TO RELATED APPLICATION

The present application is based on and claims priority to Chinese Patent Application No. 201710818502.9, filed on Sep. 12, 2017, which is incorporated herein by reference in its entirety.

### TECHNICAL FIELD

The present disclosure relates to the field of computer technologies, and in particular, to a method, an apparatus, and an electronic device for risk feature screening and descriptive message generation.

### BACKGROUND

As Internet finance develops rapidly, the quantity of financial transactions on the Internet is growing fast. Among a large number of financial transactions on the Internet, there may be some illegal transactions, such as money laundering. Therefore, there is a need for identifying suspicious transactions from a large number of transaction records, to generate corresponding descriptive messages of the suspicious transactions, and to report to relevant authorities. These suspicious transactions may also be referred to as risk events.

According to existing solutions, the descriptive messages describing the suspicious transactions are typically composed manually by employees of relevant organizations based upon data of suspicious transactions and a predefined message template. The message's length is usually constrained.

There is a demand to develop a solution where more informative descriptive messages may be generated for the suspicious transactions.

### SUMMARY

Embodiments of the present disclosure provide a risk feature screening method, a descriptive message generation method, apparatuses, and electronic devices for generating more informative descriptive messages for suspicious transactions according to constraints on the length of messages.

According to one aspect, a method for risk feature screening according to the embodiments of the present disclosure may comprise:

acquiring respective feature weights of a plurality of risk features, wherein the feature weights are either obtained by using a classification model trained using sample events or predefined, and wherein the classification model is used to determine risk events; and

selecting at least a part of the plurality of risk features through screening according to the feature weights and a predetermined constraint for limiting the length of a message generated based on the risk features.

In some embodiments, obtaining the feature weights by using the classification model trained using sample events may comprise: obtaining a classification model through training using sample events; and executing the following for each of the plurality of risk features, respectively: acquiring data corresponding to the risk feature in the sample events; calculating, according to the data corresponding to the risk feature, a classification accuracy metric of the risk feature corresponding to the classification model; and obtaining a feature weight of the risk feature according to the classification accuracy metric.

In some embodiments, each of the plurality of risk features has a corresponding sub-message word count respectively. Selecting at least a part of the plurality of risk features through screening according to the feature weights and the predetermined constraint may comprise: performing a first sorting on the plurality of risk features according to the feature weights and corresponding sub-message word counts; and selecting at least a part of the plurality of risk features through screening according to the first sorting result, the sub-message word counts, and the predetermined constraint.

In some embodiments, performing the first sorting on the plurality of risk features according to the feature weights and the corresponding sub-message word counts may comprise: performing a second sorting on the plurality of risk features according to the feature weights to determine a second sorting result; selecting at least a part of the plurality of risk features from the plurality of risk features according to the second sorting result; and performing the first sorting on the selected risk features according to the feature weights and the corresponding sub-message word counts.

In some embodiments, performing the first sorting on the plurality of risk features according to the feature weights and corresponding sub-message word counts may comprise: calculating unit word count weights corresponding to the risk features based on the feature weights and the sub-message word counts corresponding to the risk features; and performing the first sorting on the plurality of risk features according to the unit word count weights.

In some embodiments, selecting at least a part of the plurality of risk features through screening according to the first sorting result, the sub-message word counts, and the predetermined constraint may comprise: traversing, in a descending order of the unit word count weights, all risk features included in the first sorting result and executing the following for a current risk feature: adding the current risk feature into a defined set, and determining whether a sum of the word counts of the sub-messages corresponding to risk features included in the defined set satisfies the predetermined constraint; if it is determined that the sum of the word counts satisfies the predetermined constraint, traversing to the next risk feature; otherwise, deleting the current risk feature from the defined set, terminating the traversing process, and using the risk features included in the defined set as the selected risk features.

In some embodiments, traversing to the next risk feature may comprise: obtaining a value of a classification accuracy metric of the defined set corresponding to the classification model; determining whether the value of the classification accuracy metric of the defined set is not greater than a value of the classification accuracy metric of the defined set before the addition of the current risk feature; if it is determined that the value of the classification accuracy metric of the defined set is not greater than a value of the classification accuracy metric of the defined set before the addition of the current risk feature, deleting the current risk feature from the defined set and traversing to the next risk feature; otherwise, traversing to the next risk feature.

In some embodiments, the classification accuracy metric may comprise an area under receiver operating characteristic curve (AUC).

In some embodiments, the method may further comprise acquiring an event to be described; generating a sub-message corresponding to the event to be described with respect to each of the screened at least some risk features; and generating a descriptive message for the event to be described according to the sub-messages.

In some embodiments, the event to be described may be determined as a risk event by the classification model, and the risk event may be a suspected money laundering transaction.

According to a second aspect, a descriptive message generation method according to the embodiments of the present disclosure may comprise:

acquiring an event to be described;

determining one or more risk features through screening; and

generating a descriptive message for the event to be described according to the determined one or more risk features;

wherein determining the one or more risk features through screening comprises: acquiring respective feature weights of a plurality of risk features, and selecting the one or more risk features through screening the plurality of risk features according to the feature weights and a predetermined constraint, wherein the feature weights is either obtained by using a classification model trained by using sample events or predefined, the classification model is used to determine risk events, and the predetermined condition is used to limit the length of a message generated based on the risk features.

According to a third aspect, a risk feature screening device according to the embodiments of the present disclosure may comprise: one or more processors; and a memory storing instructions that, when executed by the one or more processors, cause the device to perform: acquiring respective feature weights of a plurality of risk features, wherein the feature weights are either obtained by using a classification model trained using sample events or predefined, and wherein the classification model is used to determine risk events; and selecting at least a part of the plurality of risk features through screening according to the feature weights and a predetermined constraint for limiting the length of a message generated based on the risk features.

The embodiments of the present disclosure can achieve the following advantageous effects: a classification model obtained through training can be used to determine respective feature weights of risk features, and a descriptive message can be generated for an event to be described according to the risk features and a predetermined constraint for limiting the length of a message generated based on the risk features, such that the generated descriptive message is more informative. The descriptive message can be, for example, a suspicious transaction such as a suspicious money laundering transaction.

### BRIEF DESCRIPTION OF THE DRAWINGS

To more clearly describe technical solutions in the embodiments of the present disclosure, the accompanying drawings to be used in the description of embodiments will be described briefly below. The accompanying drawings described below are merely a part of embodiments of the present disclosure. A person skilled in the art can further obtain other drawings according to these drawings without inventive effort.

FIG. 1 is a schematic diagram of an architecture of a system according to various embodiments of the present disclosure.

FIG. 2 is a flow chart of a risk feature screening method according to various embodiments of the present disclosure.

FIG. 3 is a flow chart of a descriptive message generation method according to various embodiments of the present disclosure.

FIG. 4 is a schematic diagram of a screenshot of a portion of a descriptive message according to various embodiments of the present disclosure.

FIG. 5 is a schematic diagram of an automatic message generation algorithm according to various embodiments of the present disclosure.

FIG. 6 is a schematic diagram of a suspicious transaction screening process according to various embodiments of the present disclosure.

FIG. 7 is a schematic structural diagram of a risk feature screening apparatus corresponding to FIG. 2 according to various embodiments of the present disclosure.

FIG. 8 is a schematic structural diagram of a descriptive message generation apparatus corresponding to FIG. 3 according to various embodiments of the present disclosure.

FIG. 9 is a diagram of an electronic device for generating descriptive messages according to various embodiments of the present disclosure.

### DETAILED DESCRIPTION

The embodiments of the present disclosure provide method, apparatus, and electronic devices for risk feature screening and descriptive message generation.

To make the technical solutions of this application more comprehensible for people skilled in the art, the technical solutions in the implementations of this application are provided in the following with reference to the accompanying drawings. The implementations to be presented are merely a part rather than all of the implementations. All other implementations obtainable by people of ordinary skill in the art based on the disclosed implementations without making creative efforts shall fall within the protection scope of the present disclosure.

To facilitate the understanding of the present disclosure, the concept of the solutions of the present disclosure is analyzed below.

In some embodiments, when there is no constraint on a message's length, a descriptive message may be generated to cover all information points of a suspicious transaction, where each information point may correspond to data of one of risk features of the suspicious transaction respectively. For example, an information point may be a sub-message generated according to a risk feature. A set of all risk features may be referred to as S.

In some embodiments, when there is a constraint on a message's length, a descriptive message typically may only cover a portion of, rather than all, risk features of a suspicious transaction. Otherwise, the message's length may go beyond the limit. To create an informative descriptive message, risk features may be screened to identify a subset of the risk features which have the highest referential value, and the subset of the risk features may be referred to as S′⊆S. Assume that an area under Receiver Operating Characteristic (ROC) curve (AUC) of a classification model is used to measure the referential value of S′. One goal is to obtain, through screening, the S′ corresponding to the maximum AUC.

This is a problem of combinatorial optimization. However, when there is a great number of risk features, it is not feasible to do combinatorial optimization due to tremendous computational cost. Therefore, present disclosure uses a greedy search strategy to find an approximate solution of the combinatorial optimization problem, and obtain a local optimal solution, which can reduce the computational cost and achieve a high efficiency.

The solutions of the present disclosure may be used to select the risk features with relatively high referential values through screening a set of risk features; and may be further used to generate a descriptive message for a risk event such as a suspicious transaction by using the selected risk features.

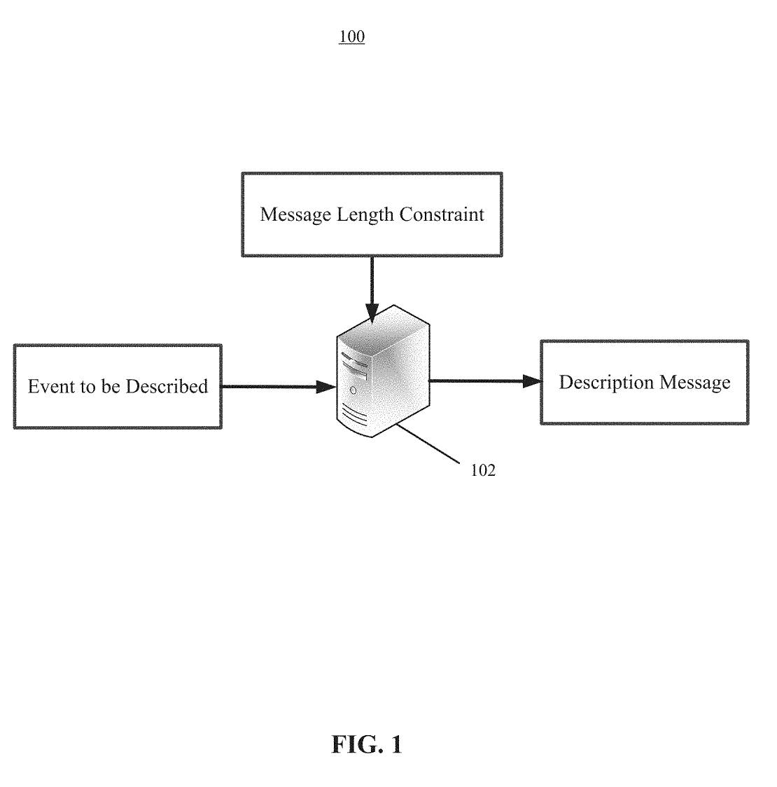

FIG. 1 is a schematic diagram of an architecture of a system 100 according to various embodiments of the present disclosure. The system 100 comprises a computer device 102, and the work flow of the computer device 102 mainly comprises: determining a plurality of risk features to be screened, and selecting at least a part of the plurality of risk features through screening; and receiving an event to be described, and generating a descriptive message according to the event to be described and the risk features selected through screening. In some embodiments, the computer device 102 may include a classification model for determining risk events.

Based on the architecture of the system 100, embodiments of the present disclosure will be described in detail below.

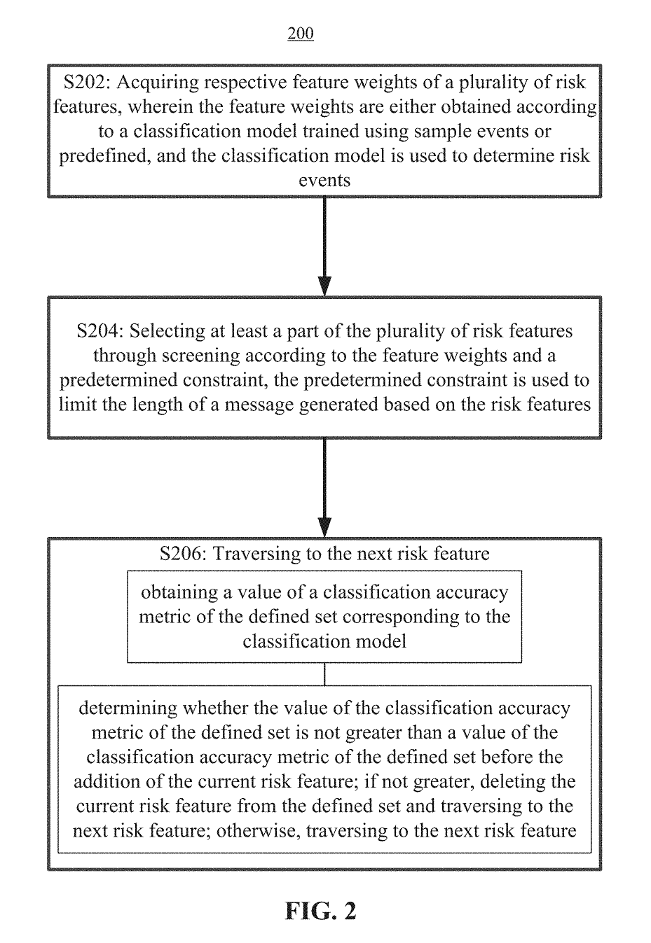

The embodiments of the present disclosure provide a risk feature screening method 200 as shown in FIG. 2. In the illustrated embodiments, the method 200 may comprise a step S202: acquiring respective feature weights of a plurality of risk features, where the feature weights are either obtained by using a classification model trained using sample events or predefined, and the classification model is used to determine risk events.

In the embodiments of the present disclosure, there may be a plurality of sample events. For the same risk feature, different sample events may have different feature values. In some embodiments, a classification model may be obtained through training by using the sample events. The trained classification model may be used to determine a feature weight corresponding to a risk feature.

For example, a feature weight may be obtained by calculating an accuracy metric for classification of a risk feature based on the classification model. The classification accuracy metric may be, for example, AUC, information entropy, or a classification accuracy rate.

In some embodiments, a feature weight may be obtained through pre-definition, rather than relying on a classification model.

In some embodiments, a feature weight describes a degree of importance of a risk feature. A risk feature with a high feature weight may be preferably selected to describe an event. In some embodiments, due to the limit on a message's length (i.e., the above described predetermined constraint), a feature weight may not necessarily be the only basis for screening risk features. For example, screening may be performed in combination with other factors, e.g., a sub-message's length corresponding to a risk feature.

A risk event may be a suspicious transaction, e.g., a suspected money laundering transaction, a transaction suspected to have been conducted by a fraud. A risk event may also be a suspicious operation other than transactions, e.g., an illegal log-in.

The method 200 may also comprise a step S204: selecting at least a part of the plurality of risk features through screening according to the feature weights and a predetermined constraint for limiting the length of a message generated based on the risk features.

Through the method 200 shown in FIG. 2, risk features with high referential values may be selected through screening. Based on the method 200 shown in FIG. 2, the embodiments of the present disclosure further provide detailed and expanded implementations, which will be described below.

In the embodiments of the present disclosure, pre-defining risk features may be performed according to operators' experience. The description below will focus on the other manner in which risk features are obtained.

With regard to the step S202 in method 200, obtaining the feature weights by using a classification model trained by using sample events may, for example, comprise: obtaining a classification model through training by using sample events; executing the following for each of the plurality of risk features, respectively: acquiring data corresponding to the risk feature in the sample events; calculating, according to the data corresponding to the risk feature, an accuracy metric for the classification of the risk feature according to the classification model; obtaining a feature weight of the risk feature according to the classification accuracy metric.

In the embodiments of the present disclosure, the classification accuracy metric for the classification of the risk feature according to the classification model may indicate an accuracy of classification of sample events where data of the sample events corresponding to the risk feature is used alone as an input to the classification model. For example, if the classification accuracy metric is AUC, a higher AUC means a higher classification accuracy.

The classification model may be a random forest model, a logic regression model, etc. Using the random forest model as an example, assume that a training sample set is D=(x, y), wherein x∈Rⁿ*^{d} is the model's input data, e.g., data of sample events; y∈Rⁿ*¹ is a sample label indicating, for example, whether a sample event involves money laundering, or whether it is a suspected money laundering transaction; then, according to the training sample data x and the sample label y, a decision tree may be constructed, and the random forest model may be obtained through training based on a plurality of constructed decision trees.

In the embodiments of the present disclosure, sub-messages corresponding to risk features may be generated according to data of the risk features. The risk features each has a corresponding sub-message word count respectively, and the sub-message word count may be pre-determined or pre-estimated.

In such a circumstance, with regard to the step S204 in method 200, selecting at least a part of the risk features through screening according to the feature weights and a predetermined constraint may comprise: performing a first sorting on the risk features according to the feature weights and corresponding sub-messages' word counts; and selecting at least a part of the risk features through screening according to a result of the first sorting, the sub-messages' word counts, and the predetermined constraint.

In some embodiments, a sub-message's word count may be a predetermined word count for a sub-message template which is pre-defined for risk features. The sub-message template may comprise risk features and corresponding descriptive statements, and may pre-establish a corresponding relationship between each risk feature and each descriptive statement. For example, the relationship may be represented by <feature 1, description statement 1>, <feature 2, description statement 2>, and <feature 3, description statement 3>. A sub-message may be obtained by substituting a risk feature with a particular value of the risk feature. The default word count of a descriptive statement may be the above described predetermined word count.

Furthermore, performing the first sorting on the risk features according to the feature weights and corresponding sub-message word counts may, for example, comprise: performing a second sorting on the risk features according to the feature weights to determine a second sorting result; selecting at least a part of the risk features based on the second sorting result; performing the first sorting on the selected risk features according to the feature weights and corresponding sub-message word counts.

In some embodiments, when there are a large number of risk features, processing such as sorting and/or pre-screening may be first performed on the risk features. Then screening of the pre-processed risk features may be performed. This is beneficial for saving processing resources consumed in the screening process.

For example, the second sorting may be performed on the risk features according to a descending order of the feature weights. The risk features at the back of the second sorting result may be eliminated and the risk features at the front of the second sorting result may be retained.

A pre-screening (such as the above described second sorting) is an optional, but not a necessary step. Whether to conduct it may depend on actual needs.

In the embodiments of the present disclosure, performing the first sorting on the risk features according to the feature weights and corresponding sub-message word counts may, for example, comprise: calculating unit word count weights corresponding to the risk features based on the feature weights and the sub-message word counts corresponding to the risk features; performing the first sorting on the risk features according to the unit word count weights.

In some embodiments, the unit word count weight may represent average contribution of each word in a sub-message to a corresponding feature weight thereof. For example, the unit word count weight may be equal to a feature weight divided by a corresponding sub-message word count.

In some embodiments, risk features may be sorted and screened according to other criteria than unit word count weight, e.g., an amount of unit word count information.

As described above, a greedy search strategy may be used to find an approximate solution to the present problem. A process to find an approximate solution is described and then analyzed below.

In the embodiments of the present disclosure, selecting at least a part of the risk features through screening according to the first sorting result, the sub-message word counts, and the predetermined constraint may comprise:

traversing, in a descending order of the unit word count weights, all risk features included in the first sorting result, and executing the following for a current risk feature:

adding the current risk feature into a defined set, and determining whether a sum of the word counts of the sub-messages corresponding to the risk features included in the defined set satisfies the predetermined constraint; if it is determined that the sum of the word counts satisfies the predetermined constraint, traversing to the next risk feature; otherwise, deleting the current risk feature from the defined set, terminating the traversing process, and using the risk features included in the defined set as the screened risk features; where the defined set initially may be an empty set.

In some embodiments, even if the determination result is negative (e.g., it is determined that the sum of the word counts of the sub-messages corresponding to the risk features included in the defined set goes beyond the predetermined constraint), the traversing process may not be terminated (although the current risk feature may be deleted from the defined set). For example, an attempt may be made to continue sequentially selecting and adding one or more following risk features into the defined set and to check if the predetermined constraint is satisfied.

In the embodiments of the present disclosure, with regard to the step S206, traversing to the next risk feature may comprise:

obtaining a value of a classification accuracy metric of the defined set corresponding to the classification model;

determining whether the value of the classification accuracy metric of the defined set is not greater than a value of the classification accuracy metric of the defined set before the addition of the current risk feature; if not greater, deleting the current risk feature from the defined set and traversing to the next risk feature; otherwise, traversing to the next risk feature.

To avoid confusion, an example is provided to describe the defined set before the addition of the current risk feature. For example, nine risk features have been added into the defined set (assuming that the defined set at this loop is referred to as the current set), and at this loop the 10th risk feature is to be added subsequently (i.e., the current risk feature). Therefore, the defined set before the addition of the current risk feature is referred to as the current set.

The process to use a greedy search strategy to find an approximate solution has been described above, and it is analyzed below.

To achieve the above described goal, it may be required to exhaust the risk feature subsets S′ to find the maximal S′ of a corresponding AUC (one example of the classification accuracy metric) satisfying the message length constraint.

However, the greedy search strategy may avoid exhaustion of the risk feature subsets S′. In some embodiments, according to the greedy search strategy, selection of a risk feature from the first sorting result at each time may be optimized. For example, the optimal risk feature among the remaining risk features in the first sorting result may be selected in each loop until the message's length constraint is reached. In the example described above, the optimal risk feature may be the risk feature with the greatest unit word count weight. Additionally, it is approximately assumed that the corresponding AUC may increase after each addition of a risk feature, thereby eliminating the need to calculate the corresponding AUC each time, saving processing resources, and improving efficiency of the screening.

In some embodiments, to be more accurate, an AUC may be calculated each time. The reason is that a newly added risk feature may also potentially decrease the AUC; in such a case, this risk feature may be eliminated.

For example, if a risk feature S⁽ⁱ⁾ has a strong correlation with the obtained defined set S′, or the noise included in S⁽ⁱ⁾ is significant, then the risk feature S⁽ⁱ⁾ may cause the classification capability of the classification model to decrease or remain unchanged (i.e., the classification accuracy metric decreases or remains unchanged), and then S⁽ⁱ⁾ may be deleted from S′.

In the embodiments of the present disclosure, a descriptive message may be further generated based on the screening of risk features for a risk event to be described, e.g., a suspected money laundering transaction, where whether it is a risk event may be determined by the above classification model or according to personal experience.

For example, an event to be described may be acquired. Sub-messages corresponding to the event to be described may be generated with respect to at least a part of the risk features selected through screening, respectively. The sub-messages may be assembled to obtain a descriptive message of the event to be described. In addition, to improve the efficiency, a pre-defined sub-message template may be used to generate the sub-messages.

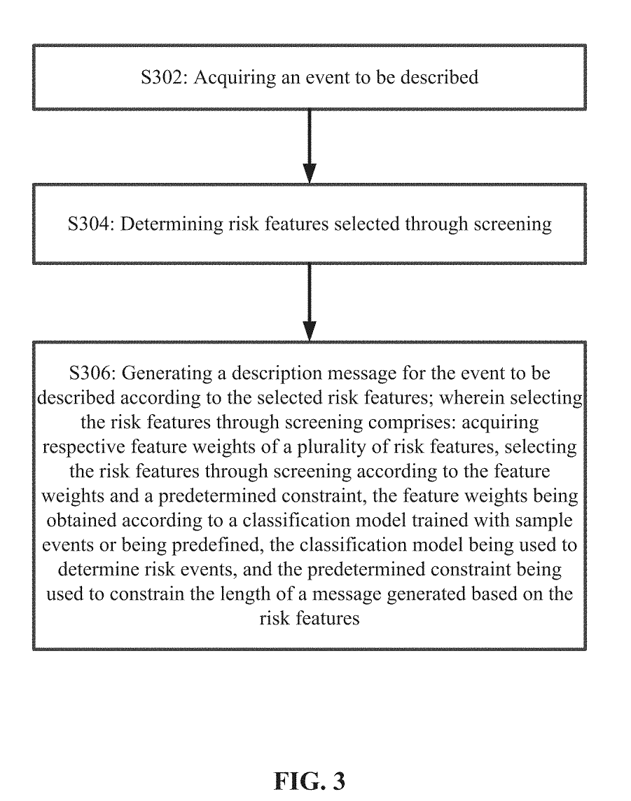

Based on the same concept, the embodiments of the present disclosure further provide a flow chart of a descriptive message generation method, as shown in FIG. 3.

The method shown in FIG. 3 may comprise the following steps:

S302: acquiring an event to be described; and

S304: determining one or more risk features through screening.

In the embodiments of the present disclosure, the risk features may be either pre-screened before this method is executed or screened after an event to be described is acquired.

The method in FIG. 3 may further comprise step S306: generating a descriptive message for the event to be described according to the determined one or more risk features. In some embodiments, determining the risk features through screening may comprise: acquiring respective feature weights of a plurality of risk features, and selecting the one or more risk features through screening the plurality of risk features according to the feature weights and a predetermined constraint, wherein the feature weights may be either obtained by using a classification model trained using sample events or predefined, the classification model may be used to determine risk events, and the predetermined constraint may be used to limit the length of a message generated based on the risk features.

In some embodiments, the risk features may be screened at the same time when a corresponding sub-message is generated, or the sub-message may be generated after the risk features have been screened. Subsequently, a descriptive message including sub-messages may be obtained.

The method shown in FIG. 3 may facilitate the generation of a more informative descriptive message for an event to be described.

The embodiments of the present disclosure further provide an example of content of a descriptive message generated for a suspicious transaction. The descriptive message may comprise, for example, six parts of contents, each part corresponding to one or more risk features.

The first part may be a summary of the suspicious transaction.

The second part may be a description of the process of the suspicious transaction, including, e.g., time, location, and other information.

The third part may be information of a suspicious account, including, e.g., basic account information, user profile, etc.

The fourth part may be an overall situation of the suspicious transaction, including, e.g., a time period of the transaction, transaction numbers and amount involved in the transactions, sources and uses of the funds, transaction flows, and the like.

The fifth part may be an analysis of suspicious points. All suspicious points may be listed one by one, including, e.g., information regarding account opening or closing and other suspicious information in a transaction process.

The sixth part may be a conclusion for the message. For example, the suspicious transaction may be given a final label (e.g., a suspected money laundering transaction) according to a determination based on data analysis and subjective judgement.

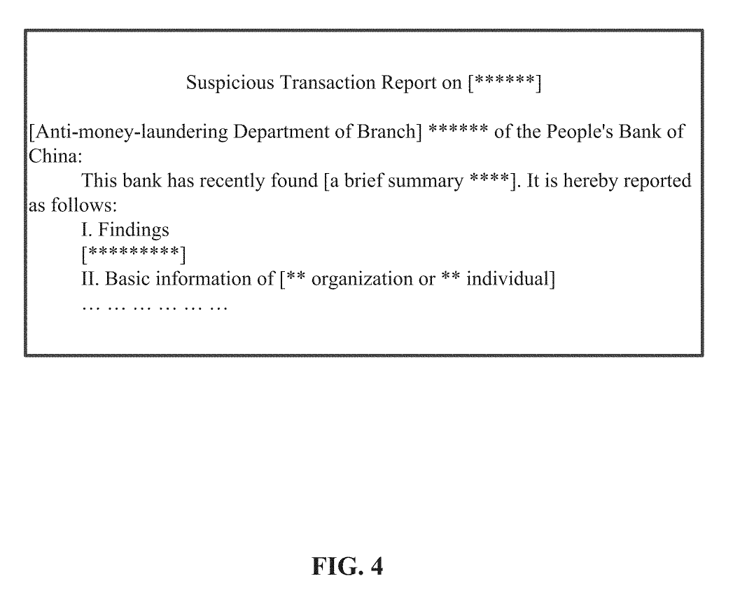

FIG. 4 is a schematic diagram of a screenshot of a partial descriptive message according to some embodiments of the present disclosure. A part of the contents in the above described six parts is illustrated in FIG. 4. The descriptive message generated according to the embodiments of the present disclosure makes key points stand out, and does not go beyond the length limitation.

In some embodiments, two types of descriptive messages may be generated for a suspected money laundering transaction. One type may be the descriptive messages set forth in the above embodiments, which may also be referred to as definite messages and may be typically obtained directly from objective data without subjective analytical data involved. The other type may be referred to as uncertain messages, which may involve subjective analytical data. In such a circumstance, the above described message length constraint may be used to constrain the definite messages.

Based on the same concept, the embodiments of the present disclosure may provide a modeling solution for automatically generating a descriptive message based on suspected money laundering transactions. The solution may comprise the following steps:

Providing a labeled training sample set D(X,Y), wherein X∈Rⁿ*^{d} is sample model's input data; Y∈Rⁿ*¹ are sample labels, and a sample label may indicate whether a sample event is a money laundering transaction.

The set including a plurality of risk features of training samples is referred to as S, and |S|=d; a classification model f(D) of D is provided, which is used to find a sub-set S′⊆S including at least a part of the risk features in set S, where the corresponding definite message is referred to as M(S′), and the length of M(S′) is not greater than a provided threshold λ−θ, i.e., |M(S′)|≤λ−θ, wherein λ is a total length constraint of a definite message and an uncertain message, θ is a length constraint of the uncertain message, and then λ−θ is a length constraint of the definite message (i.e., the above predetermined message length constraint). These length constraints are typically predetermined according to practices (e.g., different reviewers, different environments, and the like).

An ideal goal is to select an optimal feature set S*⊆S through screening, such that the data set corresponding to S* has the maximal AUC result AUC(D,S′,f) under the classifier f(D(S*)), namely, the following problem of combinatorial optimization is to be solved:

S*=argmax_{|S′|}AUC(D,S′,f);

s.t.:|M(S′)|≤λ−θ;

where, the target function AUC(D,S′,f) represents an AUC of D under the classifier f(X) at each time when a feature subset S′ is selected according to a solution.

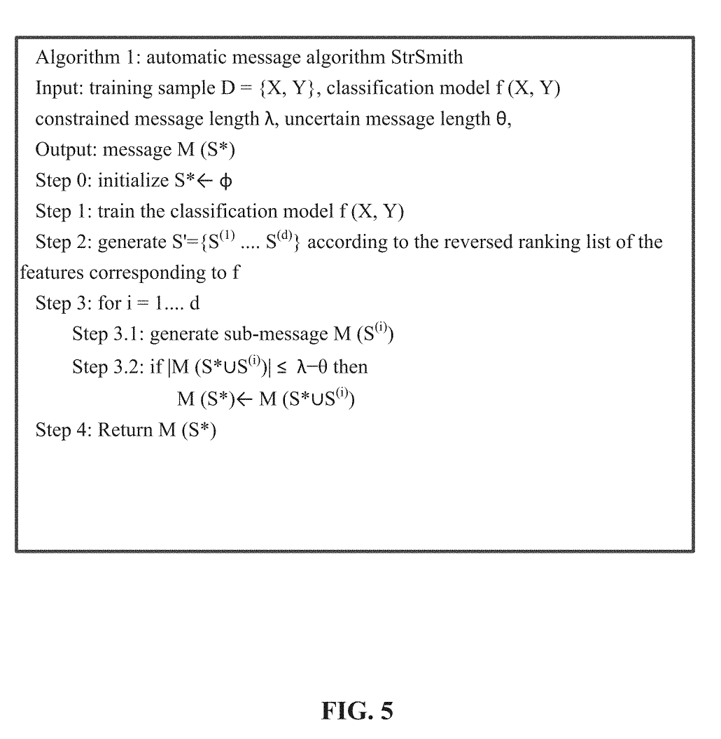

As can be seen from the above analysis, the cost to achieve such an ideal target is relatively high. Therefore, to take the next best option, a greedy search strategy may be used to find an approximate solution. FIG. 5 is a schematic diagram of an automatic message algorithm according to some embodiments of the present disclosure, which shows a process to find such an approximate solution.

In FIG. 5, the reversed ranking list of features is the above described second sorting result, S′ is the above described defined set, and the step 3 is the above described process of traversing and screening risk features. Further, in the illustrated embodiments of FIG. 5, the risk features are screened at the same time when the sub-messages are generated, and when the screening of risk features is completed, the sub-messages that form a definite message have been obtained.

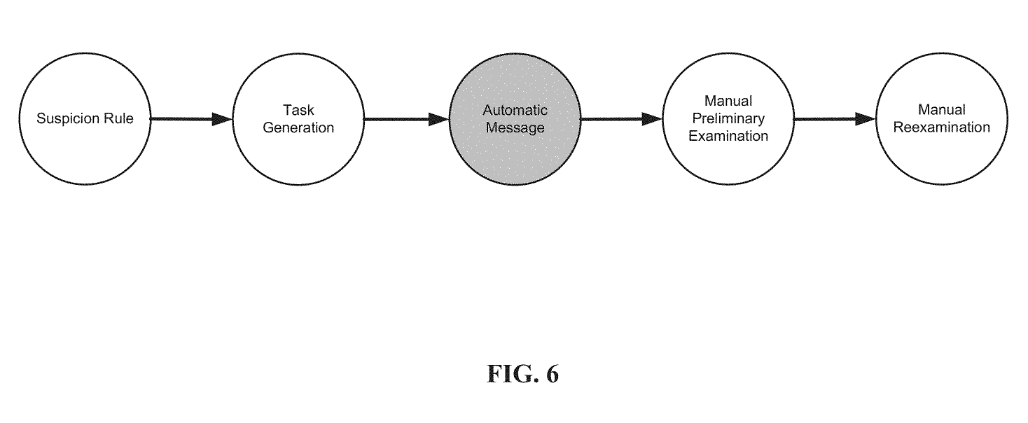

Furthermore, the embodiments of the present disclosure also provide a schematic diagram of a suspicious transaction screening process, as shown in FIG. 6.

The process in FIG. 6 may mainly comprise: generating a descriptive message generation task based on a suspicion rule, wherein the task is for a suspected money laundering transaction; further, the solutions of the present disclosure may be used to automatically execute this task (i.e., to generate a descriptive message for a suspected money laundering transaction); and then manual preliminary examination and manual re-examination may be performed on the descriptive message.

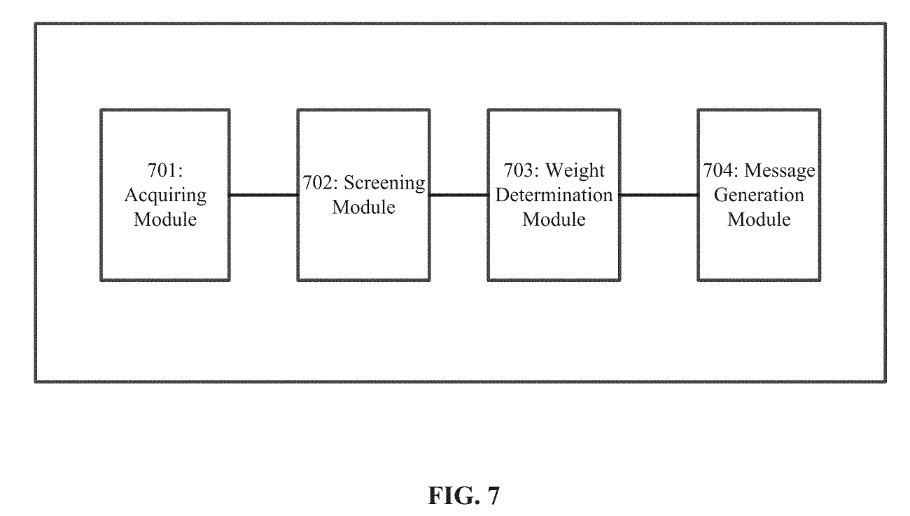

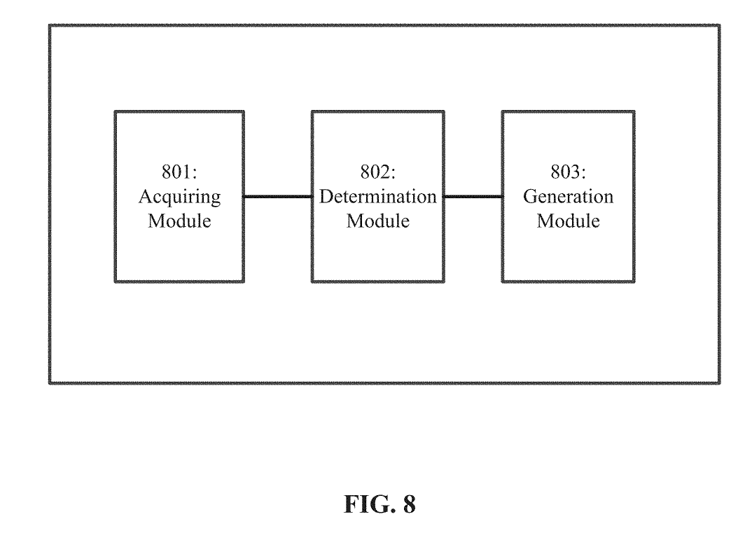

Based on the same concept, the embodiments of the present disclosure further provide corresponding apparatuses, as shown in FIG. 7 and FIG. 8.

FIG. 7 is a schematic structural diagram of a risk feature screening apparatus corresponding to the risk feature screening method in FIG. 2, according to some embodiments of the present disclosure. In the illustrated embodiments of FIG. 7, the risk feature screening apparatus may comprise:

an acquiring module 701 configured to acquire respective feature weights of a plurality of risk features, wherein the feature weights are either obtained by using a classification model trained by using sample events or predefined, and the classification model is used to determine risk events; and

a screening module 702 configured to select at least a part of the plurality of risk features through screening according to the feature weights and a predetermined constraint for limiting the length of a message generated based on the risk features.

Optionally, the apparatus may further comprise a weight determination module 703.

The weight determination module 703 may be configured to obtain the feature weights according to the classification model trained by using sample events. Specifically, the weight determining module 703 may obtain a classification model through training with sample events;

execute the following for each of the plurality of risk features, respectively:
a. acquiring data corresponding to the risk feature in the sample events;
b. calculating, according to the data corresponding to the risk feature, a classification accuracy metric of the risk feature corresponding to the classification model; and
c. obtaining a feature weight of the risk feature according to the classification accuracy metric.

Optionally, each of the plurality of risk features respectively has a corresponding sub-message word count. The screening module 702 may select at least a part of the plurality of risk features through screening according to the feature weights and a predetermined constraint.

Specifically, the screening module 702 may perform a first sorting on the plurality of risk features according to the feature weights and corresponding sub-message word counts.

The screening module 702 may select at least a part of the plurality of risk features through screening according to a first sorting result, the sub-message word counts, and the predetermined constraint.

In some embodiments, optionally, to perform the first sorting on the plurality of risk features according to the feature weights and the corresponding sub-message word counts, the screening module 702 may determine a second sorting result obtained by performing a second sorting on the plurality of risk features according to the feature weights, select at least a part of the plurality of risk features from the plurality of risk features according to the second sorting result, and perform a first sorting on the selected risk features according to the feature weights and the corresponding sub-message word counts.

In other embodiments, optionally, to perform the first sorting on the plurality of risk features according to the feature weights and the corresponding sub-message word counts, the screening module 702 may calculate unit word count weights corresponding to the risk features according to the feature weights and the sub-message word counts corresponding to the risk features, perform a first sorting on the plurality of risk features according to the unit word count weights.

In some embodiments, optionally, to select at least a part of the plurality of risk features through screening according to the first sorting result, the sub-message word counts, and the predetermined constraint, the screening module 702 may traverse each of the risk features included in the first sorting result in a descending order of the unit word count weights, and execute the following for a current risk feature:

adding the current risk feature into a defined set, and determining whether a sum of the word counts of the sub-messages corresponding to risk features included in the defined set satisfies the predetermined constraint. If the screening module 702 determines that the sum of the word counts satisfies the predetermined constraint, the screening module 702 may traverse to the next risk feature. Otherwise, if the screening module 702 determines that the sum of the word counts go beyond the predetermined constraint, the screen module 702 may delete the current risk feature from the defined set, terminate the traversing process, and use the risk features included in the defined set as the selected at least a part of the plurality of risk features. In some embodiments, the defined set is initially an empty set.

Optionally, to traverse to the next risk feature, the screening module 702 may obtain a value of a classification accuracy metric of the defined set corresponding to the classification model, and determine whether the value of the classification accuracy metric of the defined set is not greater than a value of the classification accuracy metric of the defined set before the addition of the current risk feature. If the screening module 702 determines that the value of the classification accuracy metric of the defined set (including the current risk feature) is not greater than the value of that before the addition of the current risk feature, the screening module 702 may delete the current risk feature from the defined set and traverse to the next risk feature. Otherwise, the screening module 702 may traverse to the next risk feature (with the current risk feature included in the defined set).

Optionally, the classification accuracy metric may comprise an area under Receiver Operating Characteristic (ROC) curve (AUC).

Optionally, the apparatus in FIG. 7 may further comprise a message generation module 704 configured to acquire an event to be described, generate a sub-message corresponding to the event to be described with respect to each of the selected at least a part of the plurality of risk features, and generate a descriptive message for the event to be described according to the sub-messages.

Optionally, the event to be described may be determined as a risk event by the classification model. For example, the risk event may be a suspected money laundering transaction.

FIG. 8 is a schematic structural diagram of a descriptive message generation apparatus corresponding to the descriptive message generation method in FIG. 3, according to some embodiments of the present disclosure. The apparatus in FIG. 8 may comprise:

an acquiring module 801 configured to acquire an event to be described;

a determination module 802 configured to determine risk features selected through screening; and

a generation module 803 configured to generate a descriptive message for the event to be described according to the selected risk features.

In some embodiments, determining the risk features selected through screening may comprise: acquiring respective feature weights of a plurality of risk features, and selecting the risk features through screening according to the feature weights and a predetermined constraint, wherein the feature weights may be either obtained by using a classification model trained using sample events or predefined, the classification model may be used to determine risk events, and the predetermined constraint may be used to constrain the length of a message generated based on the risk features.

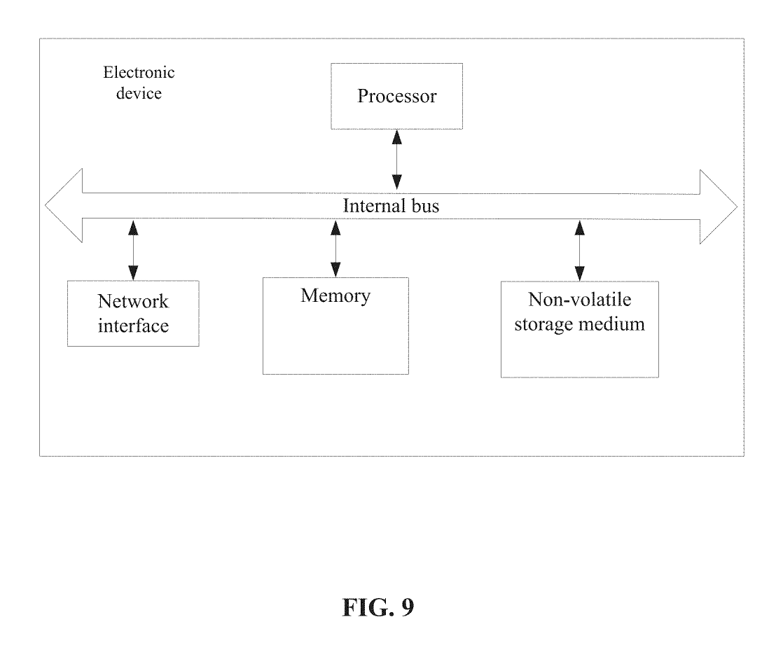

Based on the same concept, the embodiments of the present disclosure may further provide an electronic device for generating descriptive messages, as shown in FIG. 9. The electronic device in FIG. 9 may comprise at least one processor and a memory in communication with the at least one processor. The memory stores instructions executable by the at least one processor. The instructions, when executed by the at least one processor, cause the electronic device to acquire respective feature weights of a plurality of risk features. The feature weights may be obtained by using a classification model trained using sample events or predefined. The classification model may be used to determine risk events. The instructions, when executed by the at least one processor, may further cause the electronic device to select at least a part of the plurality of risk features through screening according to the feature weights and a predetermined constraint to limit the length of a message generated based on the risk features.

Based on the same concept, the embodiments of the present disclosure may further provide another electronic device, comprising at least one processor and a memory in communication with the at least one processor. The memory stores instructions executable by the at least one processor. The instructions, when executed by the at least one processor, cause the electronic device to acquire an event to be described, determine risk features selected through screening, and generate a descriptive message for the event to be described according to the selected risk features. To determine the risk features selected through screening, the instructions may further include instructions, when executed by the at least one processor, to cause the electronic device to acquire respective feature weights of a plurality of risk features, and select the risk features through screening according to the feature weights and a predetermined constraint. The feature weights may be either obtained by using a classification model trained using sample events or predefined. The classification model may be used to determine risk events, and the predetermined constraint may be used to limit the length of a message generated based on the risk features.

Based on the same concept, the embodiments of the present disclosure may further provide a non-volatile computer storage medium as shown in FIG. 9. The non-volatile computer storage medium may store computer executable instructions, and the computer executable instructions, when executed by a processor, may cause the processor to acquire respective feature weights of a plurality of risk features. The feature weights may be either obtained by using a classification model trained using sample events or predefined. The classification model may be used to determine risk events. The computer executable instructions, when executed by a processor, may further cause the processor to select at least a part of the plurality of risk features through screening according to the feature weights and a predetermined constraint for limiting the length of a message generated based on the risk features.

Based on the same concept, the embodiments of the present disclosure may further provide another non-volatile computer storage medium that may store computer executable instructions, and the computer executable instructions, when executed by a processor, may cause the processor to acquire an event to be described, determine risk features selected through screening, and generate a descriptive message for the event to be described according to the selected risk features. To determine the risk features selected through screening, the instructions may further include instructions, when executed by the at least one processor, to cause the electronic device to acquire respective feature weights of a plurality of risk features, and select the risk features through screening according to the feature weights and a predetermined constraint. The feature weights may be either obtained by using a classification model trained using sample events or predefined, the classification model may be used to determine risk events, and the predetermined constraint may be used to limit the length of a message generated based on the risk features.

Various embodiments of the present disclosure are described above. Other embodiments shall fall within the scope of the appended claims. In some embodiments, actions or steps in the claims may be executed in an order different from those in other embodiments and may still achieve expected results. In addition, a process depicted in the accompanying drawings may not be necessarily in the illustrated particular or continuous order to achieve an expected result. In some embodiments, a multi-task process or parallel process may also be feasible or may also be beneficial.

The embodiments in the present disclosure are described in a progressive manner with each embodiment focusing on differences from other embodiments, and identical or similar parts in the embodiments may be mutually referenced thereof. In particular, for the embodiments of apparatuses, electronic devices, and non-volatile computer storage media—the description thereof is relatively simple as they are substantially similar to the method embodiments. The description of the method embodiments may be referenced for related parts thereof.

The apparatuses, electronic devices, and non-volatile computer storage media correspond to the methods according to the embodiments of the present disclosure. Therefore, the apparatuses, electronic devices, and non-volatile computer storage media also have advantageous technical effects similar to those of the corresponding methods. Since the advantageous technical effects of the methods have been described in detail above, the advantageous technical effects of the corresponding apparatuses, electronic devices, and non-volatile computer storage media will not be repeated herein.

In the 1990s, an improvement of a technology may include a hardware improvement (e.g. an improvement to a circuit structure, such as a diode, a transistor, a switch, and the like) or a software improvement (e.g., an improvement to a flow of a method). Along with the technological development, however, many current improvements to method flows may be deemed as direct improvements to hardware circuit structures. Designers almost always obtain a corresponding hardware circuit structure by programming an improved method flow into a hardware circuit. Therefore, it is not that an improvement of a method flow cannot be realized through a hardware entity. For example, Programmable Logic Device (PLD) (e.g., Field Programmable Gate Array (FPGA)) is such an integrated circuit that its logic functions are determined by a user through programming the device. A designer programs by his/her own to “integrate” a digital system onto one piece of PLD, without the need to ask a chip manufacturer to design and manufacture a dedicated IC chip. Moreover, at present, this type of programming has mostly been implemented through “logic compiler” software, rather than manufacturing the IC chips manually. The logic compiler software is similar to a software compiler used for program development and composing, while a particular programming language must be used to compose source codes prior to compiling, which is referred to as a Hardware Description Language (HDL). There is not only one, but many types of HDL, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, and RHDL (Ruby Hardware Description Language). What are most commonly used right now include VHDL (Very-High-Speed Integrated Circuit Hardware Description Language) and Verilog. A person skilled in the art should also be aware that it may be very easy to obtain a hardware circuit to implement a logic method flow by performing a little logic programming using the above described HDLs programing the method into an IC.

A controller may be implemented in any proper manner. For example, a controller may be in a form of a microprocessor or processor, as well as a computer readable medium that stores computer readable program codes (e.g., software or firmware) capable of being executed by the (micro)processor, a logic gate, a switch, an Application Specific Integrated Circuit (ASIC), a programmable logic controller and an embedded microcontroller. Examples of the controller may include, but are not limited to, the following microcontrollers: ARC 625D, Atmel AT91SAM, Microchip PIC18F26K20 and Silicone Labs C8051F320. A memory controller may further be implemented as a part of a control logic of a memory. A person skilled in the art should also be aware that, in addition to that a controller is implemented in a manner of pure computer readable program codes, it is feasible to perform logic programming on steps of a method to enable a controller to implement the same functions in a form of a logic gate, a switch, an ASIC, a programmable logic controller and an embedded microcontroller. Therefore, such a controller can be deemed as a hardware component, while apparatuses included therein and configured to carry out various functions may also be deemed as a structure inside the hardware component. Alternatively, apparatuses configured to carry out various functions may even be deemed as both software modules to implement a method and structures inside a hardware component.

The system, apparatus, module or unit described in the above described embodiments may be implemented, for example, by a computer chip or entity or implemented by a product having a function. A typical implementation device is a computer. Specifically, a computer may be, for example, a personal computer, a laptop computer, a cellular phone, a camera phone, a smart phone, a personal digital assistant, a medium player, a navigation device, an email device, a game console, a tablet computer, a wearable device or a combination of any devices in these devices.

For convenience of description, the above described apparatus may be divided into various units according to functions. Functions of the units may be implemented in one or more pieces of software and/or hardware according to one or more embodiments of the present disclosure.

A person skilled in the art should understand that the embodiments of the present disclosure may be provided as a method, a system, or a computer program product. Therefore, the embodiments of the present disclosure may be implemented as a complete hardware embodiment, a complete software embodiment, or an embodiment combing software and hardware. Moreover, the embodiments of the present disclosure may be in the form of a computer program product implemented on one or more computer usable storage media (including, but not limited to, a magnetic disk memory, CD-ROM, an optical memory, and the like) comprising computer usable program codes therein.

The present disclosure is described with reference to flow charts and/or block diagrams of the method, device (system) and computer program product according to the embodiments of the present disclosure. A computer program instruction may be used to implement each process and/or block in the flow charts and/or block diagrams and a combination of processes and/or blocks in the flow charts and/or block diagrams. These computer program instructions may be provided for a general-purpose computer, a special-purpose computer, an embedded processor, or a processor of other programmable data processing devices to generate a machine, so that the instructions executed by a computer or a processor of other programmable data processing devices generate an apparatus for implementing a specified function in one or more processes in the flow charts and/or in one or more blocks in the block diagrams.

These computer program instructions may also be stored in a computer readable memory that may instruct a computer or other programmable data processing devices to work in a particular manner, such that the instructions stored in the computer readable memory generate a manufactured article that includes an instruction apparatus. The instruction apparatus may implement a specified function in one or more processes in the flow charts and/or in one or more blocks in the block diagrams.

These computer program instructions may also be loaded onto a computer or other programmable data processing devices, causing a series of operational steps to be executed on the computer or other programmable devices to generate computer-implemented processing. Therefore, the instructions executed on the computer or other programmable devices may provide steps for implementing a specified function in one or more processes in the flow charts and/or in one or more blocks in the block diagrams.

In a typical configuration, the computation device includes one or more processors (CPUs), input/output interfaces, network interfaces, and a memory.

The memory may include computer readable media, such as a volatile memory, a Random Access Memory (RAM), and/or a non-volatile memory, e.g., a Read-Only Memory (ROM) or a flash RAM. The memory is an example of a computer readable medium.

Computer readable media include permanent, volatile, mobile and immobile media, which may implement information storage through any method or technology. The information may be computer readable instructions, data structures, program modules or other data. Examples of storage media of computers include, but are not limited to, Phase-change RAMs (PRAMs), Static RAMs (SRAMs), Dynamic RAMs (DRAMs), other types of Random Access Memories (RAMs), Read-Only Memories (ROMs), Electrically Erasable Programmable Read-Only Memories (EEPROMs), flash memories or other memory technologies, Compact Disk Read-Only Memories (CD-ROMs), Digital Versatile Discs (DVDs) or other optical memories, cassettes, cassette and disk memories or other magnetic memory devices or any other non-transmission media, which can be used for storing information accessible to a computation device. According to the present disclosure, the computer readable media may not include transitory media, such as modulated data signals and carriers.

The terms of “including”, “comprising” or any other variants thereof intend to encompass a non-exclusive inclusion, such that a process, method, commodity or device comprising/including a series of elements not only comprises/includes these elements, but also comprises/includes other elements that are not specifically listed, or further comprises elements that are inherent to the process, method, commodity or device. When there is no further restriction, elements defined by the statement “comprising one . . . ” or “including one . . . ” does not exclude that a process, method, commodity or device comprising/including the above elements further comprises/includes additional identical elements.

The present disclosure may be described in a regular context of a computer executable instruction that is executed by a computer, such as a program module. Generally, the program module comprises a routine, a program, an object, a component, a data structure, and the like for executing a particular task or implementing a particular abstract data type. The present disclosure may also be practiced in distributed computing environments. In these distributed computing environments, remote processing devices connected via communication networks carry out tasks. In the distributed computing environments, a program module may be located in local and remote computer storage media, including storage devices.

The embodiments in the present disclosure are described in a progressive manner with each embodiment focusing on differences from other embodiments, and identical or similar parts in the different embodiments may be mutually referenced thereof. In particular, for the system embodiments, the description thereof is relatively simple as they are substantially similar to the method embodiments. The description of the method embodiments may be referenced for related parts thereof.

The above embodiments are merely exemplary and are not used to limit the present disclosure. To a person skilled in the art, the present disclosure may have various modifications and changes. Any modification, equivalent substitution or improvement made within the spirit and principle of the present disclosure shall fall within the scope of the claims of the present disclosure.

What is claimed is:

1. A method for risk feature screening, comprising:
acquiring respective feature weights of a plurality of risk features, wherein the feature weights are obtained by using a classification model trained using sample events or predefined, wherein the classification model is configured to determine risk events; and
selecting at least a part of the plurality of risk features through screening according to the feature weights and a predetermined constraint for limiting the length of a message generated based on the risk features.

2. The method according to claim 1, wherein acquiring respective feature weights of a plurality of risk features using a classification model comprises:
acquiring data corresponding to a risk feature in an event;
calculating, according to the data corresponding to the risk feature, a classification accuracy metric of the risk feature corresponding to the classification model; and
obtaining a feature weight of the risk feature according to the classification accuracy metric.

3. The method according to claim 1, wherein each of the plurality of risk features has a corresponding sub-message word count, and wherein selecting at least a part of the plurality of risk features through screening according to the feature weights and the predetermined constraint comprises:
performing a first sorting on the plurality of risk features according to the feature weights and corresponding sub-message word counts; and
selecting at least a part of the plurality of risk features through screening according to the first sorting result, the sub-message word counts, and the predetermined constraint.

4. The method according to claim 3, wherein performing the first sorting on the plurality of risk features according to the feature weights and the corresponding sub-message word counts comprises:
performing a second sorting on the plurality of risk features according to the feature weights to determine a second sorting result;
selecting at least a part of the plurality of risk features from the plurality of risk features according to the second sorting result; and
performing the first sorting on the selected risk features according to the feature weights and the corresponding sub-message word counts.

5. The method according to claim 3, wherein performing the first sorting on the plurality of risk features according to the feature weights and corresponding sub-message word counts comprises:
calculating unit word count weights corresponding to the risk features based on the feature weights and the sub-message word counts corresponding to the risk features; and
performing the first sorting on the plurality of risk features according to the unit word count weights.

6. The method according to claim 3, wherein selecting at least a part of the plurality of risk features through screening according to the first sorting result, the sub-message word counts, and the predetermined constraint comprises:
traversing, in a descending order of the unit word count weights, all risk features included in the first sorting result and executing the following for a current risk feature:
adding the current risk feature into a defined set, and determining whether a sum of the word counts of the sub-messages corresponding to risk features included in the defined set satisfies the predetermined constraint; if it is determined that the sum of the word counts satisfies the predetermined constraint, traversing to the next risk feature; otherwise, deleting the current risk feature from the defined set, terminating the traversing process, and using the risk features included in the defined set as the selected risk features.

7. The method according to claim 6, wherein traversing to the next risk feature comprises:
obtaining a value of a classification accuracy metric of the defined set corresponding to the classification model;
determining whether the value of the classification accuracy metric of the defined set is not greater than a value of the classification accuracy metric of the defined set before the addition of the current risk feature; if it is determined that the value of the classification accuracy metric of the defined set is not greater than a value of the classification accuracy metric of the defined set before the addition of the current risk feature, deleting the current risk feature from the defined set and traversing to the next risk feature; otherwise, traversing to the next risk feature.

8. The method according to claim 2, wherein the classification accuracy metric comprises an area under receiver operating characteristic curve (AUC).

9. The method according to claim 1, further comprising:
acquiring an event to be described;
generating a sub-message corresponding to the event to be described with respect to each of the screened at least some risk features; and
generating a descriptive message for the event to be described according to the sub-messages.

10. The method according to claim 9, wherein the event to be described is determined as a risk event by the classification model, and the risk event is a suspected money laundering transaction.

11. A descriptive message generation method, comprising:
acquiring an event to be described;
determining one or more risk features through screening; and
generating a descriptive message for the event to be described according to the determined one or more risk features,
wherein determining the one or more risk features through screening comprises: acquiring respective feature weights of a plurality of risk features, and selecting the one or more risk features through screening the plurality of risk features according to the feature weights and a predetermined constraint, wherein the feature weights is either obtained by using a classification model trained by using sample events or predefined, the classification model is configured to determine risk events, and the predetermined constraint is configured to limit the length of a message generated based on the one or more risk features.

12. A risk feature screening device, comprising:
one or more processors; and
a memory storing instructions that, when executed by the one or more processors, cause the device to perform:
acquiring respective feature weights of a plurality of risk features, wherein the feature weights are either obtained by using a classification model trained using sample events or predefined, and wherein the classification model is configured to determine risk events; and
selecting at least a part of the plurality of risk features through screening according to the feature weights and a predetermined constraint for limiting the length of a message generated based on the risk features.

13. The device according to claim 12, wherein obtaining the feature weights by using the classification model trained using sample events comprises:
acquiring data corresponding to a risk feature in an event;
calculating, according to the data corresponding to the risk feature, a classification accuracy metric of the risk feature corresponding to the classification model; and
obtaining a feature weight of the risk feature according to the classification accuracy metric.

14. The device according to claim 12, wherein each of the plurality of risk features has a corresponding sub-message word count respectively, and wherein selecting at least a part of the plurality of risk features through screening according to the feature weights and the predetermined constraint comprises:
performing a first sorting on the plurality of risk features according to the feature weights and corresponding sub-message word counts; and
selecting at least a part of the plurality of risk features through screening according to the first sorting result, the sub-message word counts, and the predetermined constraint.

15. The device according to claim 14, wherein performing the first sorting on the plurality of risk features according to the feature weights and the corresponding sub-message word counts comprises:
performing a second sorting on the plurality of risk features according to the feature weights to determine a second sorting result;
selecting at least a part of the plurality of risk features from the plurality of risk features according to the second sorting result; and
performing the first sorting on the selected risk features according to the feature weights and the corresponding sub-message word counts.

16. The device according to claim 14, wherein performing the first sorting on the plurality of risk features according to the feature weights and corresponding sub-message word counts comprises:
calculating unit word count weights corresponding to the risk features based on the feature weights and the sub-message word counts corresponding to the risk features; and
performing the first sorting on the plurality of risk features according to the unit word count weights.

17. The device according to claim 14, wherein selecting at least a part of the plurality of risk features through screening according to the first sorting result, the sub-message word counts, and the predetermined constraint comprises:
traversing, in a descending order of the unit word count weights, all risk features included in the first sorting result and executing the following for a current risk feature:
adding the current risk feature into a defined set, and determining whether a sum of the word counts of the sub-messages corresponding to risk features included in the defined set satisfies the predetermined constraint; if it is determined that the sum of the word counts satisfies the predetermined constraint, traversing to the next risk feature; otherwise, deleting the current risk feature from the defined set, terminating the traversing process, and using the risk features included in the defined set as the selected risk features.

18. The device according to claim 17, wherein traversing to the next risk feature comprises:
obtaining a value of a classification accuracy metric of the defined set corresponding to the classification model;
determining whether the value of the classification accuracy metric of the defined set is not greater than a value of the classification accuracy metric of the defined set before the addition of the current risk feature; if it is determined that the value of the classification accuracy metric of the defined set is not greater than a value of the classification accuracy metric of the defined set before the addition of the current risk feature, deleting the current risk feature from the defined set and traversing to the next risk feature; otherwise, traversing to the next risk feature.

19. The device according to claim 13, wherein the classification accuracy metric comprises an area under receiver operating characteristic curve (AUC).

20. The device according to claim 12, wherein the memory further comprises instructions, when executed by the one or more processors, cause the device to perform:
acquiring an event to be described;
generating a sub-message corresponding to the event to be described with respect to each of the screened at least some risk features; and
generating a descriptive message for the event to be described according to the sub-messages.
